(19) United States
(12) Patent Application Publication
(10) Pub. No.: US 2005/0129121 A1
(43) Pub. Date: Jun. 16, 2005

(54) On-chip image buffer compression method and apparatus for digital image compression

(76) Inventor: Chih-Ta Star Sung, Glonn (DE)

Correspondence Address: Chih-Ta Star Sung;RM. 308, BLD. 52, NO. 195, CHUNG HSING RD., SEC. 4, CHU TUNG TOWNSHIP, HSINCHU COUNTY, 310, TW

(21) Appl. No.: 10/724,493

(22) Filed: Dec. 1, 2003

(51) Int. Cl. H04N 7/12

(52) U.S. Cl. 375/240.16; 375/240.23; 375/240.25; 375/240.24

(57) ABSTRACT

The present invention provides method and apparatus of image buffer compression for video bit stream encoding. At least one re-constructed referencing frame pixel is compressed again and stored in a storage device. During motion estimation of a video compression, a decompressing engine recovered pixels of the predetermined searching range for best match block searching. In the still image compression, a lossless compression algorithm is applied to compress pixel data of at least one line of pixels and to save the compressed pixels into a storage device, decompression mechanism recovers at least one pixel of at least one line of pixels for predicting the value of a target pixel.

### BACKGROUND OF THE INVENTION

1. Field of Invention

The present invention relates to digital image compression, and, more specifically to the on-chip temporary image buffer compression resulting in significant reduction of storage density requirement.

2. Description of Related Art

Digital image and motion video have been adopted in an increasing number of applications, which include digital camera, scanner/printer/fax machine, video telephony, videoconferencing, surveillance system, VCD (Video CD), DVD, and digital TV. In the past almost two decades, ISO and ITU have separately or jointly developed and defined some digital video compression standards including JPEG, JBIG, MPEG-1, MPEG-2, MPEG-4, MPEG-7, H.261, H.263 and H.264. The success of development of the still image and video compression standards fuels the wide applications. The advantage of image and video compression techniques significantly saves the storage space and transmission time without sacrificing much of the image quality.

FIG. 1 illustrates the basic structure of frame pixels. A frame 11 is composed of a certain amount of blocks 12, and each block 12 is composed of a certain amount of pixels 13.

Most ISO and ITU motion video compression standards adopt Y, Cb and Cr as the pixel elements, which are derived from the original R (Red), G (Green), and B (Blue) color components. The Y stands for the degree of “Luminance”, while the Cb and Cr represent the color difference been separated from the “Luminance”. In both still and motion picture compression algorithms, the 8×8 pixels “Block” based Y, Cb and Cr goes through the similar compression procedure individually.

There are essentially three types of picture encoding in the MPEG video compression standard. I-frame, the “Intra-coded” picture uses the block of 8×8 pixels within the frame to code itself. P-frame, the “Predictive” frame uses previous I-frame or P-frame as a reference to code the difference. B-frame, the “Bi-directional” interpolated frame uses previous I-frame or P-frame as well as the next I-frame or P-frame as references to code the pixel information. In principle, in the I-frame encoding, all “Block” with 8×8 pixels go through the same compression procedure that is similar to JPEG, the still image compression algorithm including the DCT, quantization and a VLC, the variable length encoding. Meanwhile, the P-frame and B-frame have to code the difference between a target frame and the reference frames.

In the non-intra picture encoding, the first step is to identify the best match block followed by encoding the block pixel differences between a target block and the best match block. For some considerations including accuracy, performance and encoding efficiency, a frame is partitioned into macro-blocks of 16×16 pixels for estimating the block pixel differences and the block movement, called “motion vector”, the MV. Each macro-block within a frame has to find the “best match” macro-block in the previous frame or the next frame. The procedure of searching for the best match macro-block is called “Motion Estimation”. A “Searching Range” is commonly defined to limit the computing times in the “best match” block searching. For example a +/−16 pixels in X-axis and +/−16 in Y-axis surrounding the target block's position. The computing power hunger motion estimation is adopted to search for the “Best Match” candidates within a searching range for each macro block as described in FIG. 3. According to the MPEG standard, a macro block is composed of four 8×8 “blocks” of “Luma (Y)” and one, two or four “Chroma (Cb and Cr)”. Since Luma and Chroma are closely associated, in the motion estimation, there is need of the estimation only for Luma, the Chroma, Cb and Cr in the corresponding position copy the same MV of Luma. The Motion Vector, MV, represents the direction and displacement of the movement of block of pixels. For example, an MV=(5,−3) stands for the block movement of 5 pixels right in X-axis and 3 pixel down in the Y-axis. For minimizing the time of searching, the motion estimator searches for the best match macro-block only within a predetermined searching range 33, 36. By comparing the mean absolute differences, MAD or sum of absolute differences, SAD, the macro-block with the least MAD or SAD is identified as the “best match” macro-block. Once the best match blocks are identified, an MV between a target block 35 and the best match blocks 34, 37 are calculated and the difference between each block within a macro block are coded accordingly, and this kind of block pixel differences encoding technique is called “Motion Compensation”. In the procedure of the motion estimation and motion compensation, the higher accuracy of the best match block, the less bit number is needed in the encoding since the block pixel differences is smaller when the accuracy is higher.

FIG. 2 shows a prior art block diagram of the MPEG video compression, which is adopted by most video compression IC and system suppliers. In the case of I-frame or I-type macro block encoding, the MUX 220 selects the coming pixels 21 to directly go to the DCT, the Discrete Cosine Transform block 23, before the Quantization step 25. The quantized DCT coefficients are zig-zag scanned and packed as pairs of “Run-level” code, which patterns depending on the occurrence are later counted and assigned codes with variable length 26 to represent it. The compressed I-frame or/and P-frame bit stream will then be reconstructed by the inverse route of compression procedure 28 and be stored in a referencing frame buffer 26 as references for future frames. In the case of a P-type or B-type frame or macro block encoding, the macro block pixels are sent to the motion estimator 24 to compare with pixels within macro-block of previous frame for the searching of the best match macro-block. The Predictor 22 calculates the pixel difference between a target 8×8 block and the best match block of previous frame (and next frame if B-type frame). The block pixel differences are then fed into the DCT 23, quantization 25 and VLC 26 encoding, a similar procedure like the I-frame or I-type macro-block encoding.

The reconstructed frames for referencing occupy high volume of storage device and are most commonly stored in off-chip memory buffer 29 like DRAM. Integrating the reconstructed referencing frames into the video encoder causes sharp increase of price of silicon die due to high volume of the required storage device. For example, in the CIF size, 352×288 pixels 4:2:0 format, frame resolution, the required volume of storage is 304 K Byte or 2,422,024 bits (352×288×8×1.5×2). Higher resolution requires linearly higher volume of storage device.

In the still image compression, like JPEG and JBIG, a bi-level lossless compression needs no reference, and the compression is done by the picture itself. Due to higher volume of pixel per inch than JPEG or MPEG applications, the line buffer required for prediction in JBIG compression is high cost of silicon die. Taking 3000 dpi, (dot per inch) as an example, compressing an A4 size, 11×8 inches document by using JBIG requires at least 99K bits (11 inch×3000 dpi×3 lines=99K bits) of storage. In the VLSI chip implementation, an JBIG codec requires about 30K-40K logic gates, which means the 3 lines of image buffer will dominates more than 85% of die area since storage of each bit is equivalent to about 4 logic gates.

In summary, it is important and valuable to find a method for reduce the storage needed for storing reference frames or line buffer. In addition, it is also important to make image pixel buffers easier to be integrated with the video encoders or JBIG codec chips.

### SUMMARY OF THE INVENTION

The present invention is related to a method and apparatus of the image buffer compression, which plays an important role in digital video compression and line buffer compression, specifically in compressing the referencing frame buffer. The present invention significantly reduces required storage device of referencing buffer.
The present invention of the image buffer compression includes procedures and apparatus of compressing the reconstructed frame pixel data which significantly reduces the volume of storage device for P-type or B-type frame reference in digital video applications.
The present invention of the image buffer compression recovers pixels of a searching range and store into a temporary memory for the best match block comparing in P-type and B-type frame encoding.
The present invention of the image buffer compression compresses the pixel data with lossless algorithm to save pixel data for storage and recovers the compressed pixel into “block” of pixels for the JPEG still image compression which takes only 8×8 pixel as the compression unit.
The present invention of the image buffer compression compresses the data of a certain amount of lines pixel in JBIG bi-level lossless compression.
The present invention of the image buffer compression recovers the compressed line buffer pixels to be a much smaller amount of pixels for prediction in JBIG bi-level compression.

It is to be understood that both the foregoing general description and the following detailed description are by examples, and are intended to provide further explanation of the invention as claimed.

### BRIEF DESCRIPTION OF THE DRAWINGS

FIG. 1 illustrates the structure of frame pixels.

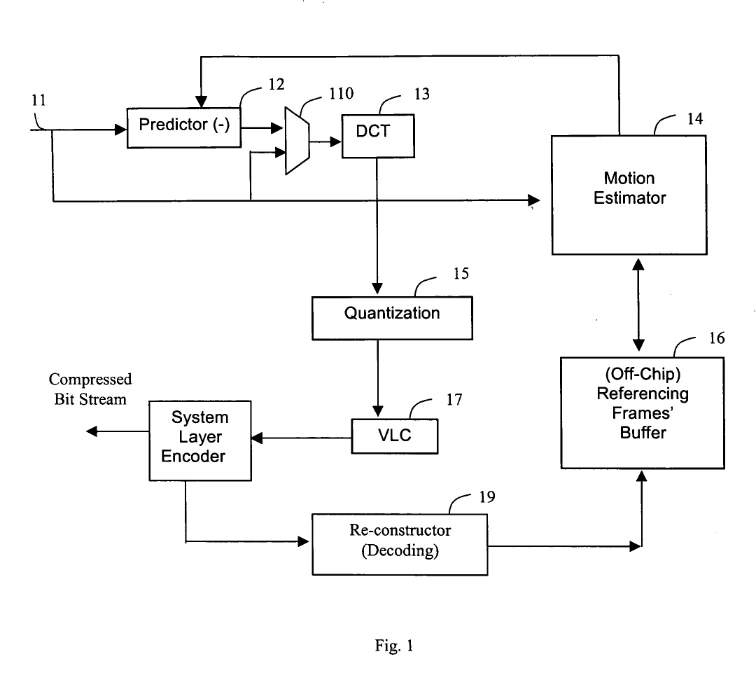

FIG. 2 shows a simplified block diagram of the prior art video compression encoder.

FIG. 3 is an illustration of the best match macroblock searching from a previous frame and a next frame.

FIG. 4 depicts a concept of recovering the compressed image pixels of referencing frames into pixels of searching range for motion estimation in the P-type and B-type frame encoding.

FIG. 5 illustrates the block diagram of the present invention of image buffer compression and decompression in digital video encoding scheme.

FIG. 6 shows a brief block diagram of the JBIG compression. There are up to three lines of pixels stored in the pixel buffer for pixel value prediction before entering the compression procedure.

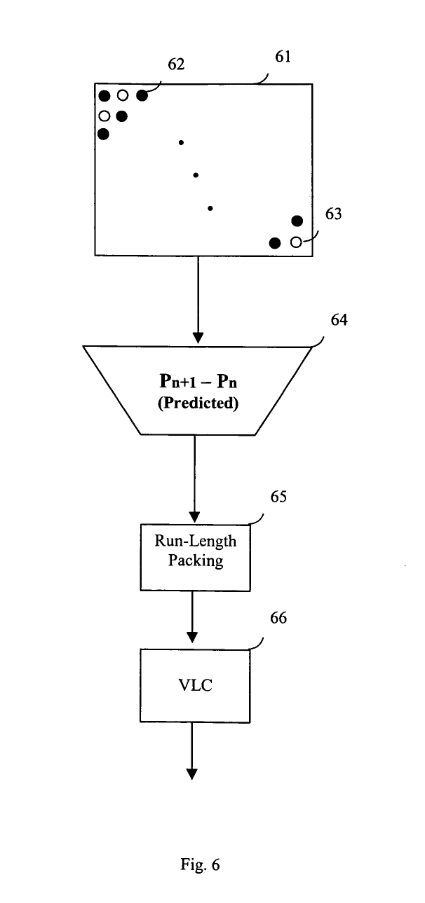

FIG. 7 depicts the block diagram of the present invention applying to the line pixel buffer compression in JBIG compression. The coming pixel are compressed and stored into a small temporary buffer and later on, recovers for prediction and compression.

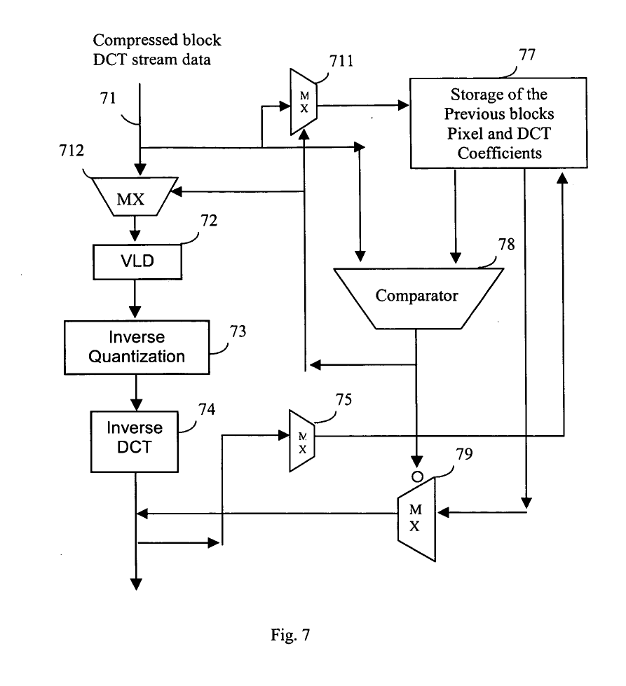

### DESCRIPTION OF THE PREFERRED EMBODIMENTS

The present invention relates specifically to the image buffer data compression in video compression and still image compression. The invented apparatus significantly reduces the amount of pixel data and stored in a smaller storage device, which makes it easier to integrate the referencing frames into a single chip with the video compression engine.

There are some compression algorithms applied to the still image compressions which come out of ITU committee including JPEG, the Joint Picture Expert Group and JBIG, Joint Bi-level Image Group. ITU and ISO have separately and jointly developed some video compression standards including MPEG and H.26x. In the JPEG still image compression, an image is partitioned into a certain amount of 8×8 pixels “Block” as a unit for DCT and Huffman compression. JBIG takes a different way for the still image compression. It uses some pixels located in upper two lines and some pixels in the left to predict the probable value of the target pixel before it enters the “Arithmetic” coding.

There are in principle three types of picture encoding in the MPEG video compression standard including I-frame, the “Intra-coded” picture, P-frame, the “Predictive” picture and B-frame, the “Bi-directional” interpolated picture. I-frame encoding uses the 8×8 block of pixels within a frame to code information of itself. The P-frame or P-type macro-block encoding uses previous I-frame or P-frame as a reference to code the difference. The B-frame or B-type macro-block encoding uses previous I- or P-frame as well as the next I- or P-frame as references to code the pixel information. In most applications, since the I-frame does not use any other frame as reference and hence no need of the motion estimation, the image quality is therefore the best of the three types of pictures, and requires least computing power in encoding. Because of the motion estimation needs to be done in both previous and next frames, bi-directional encoding, encoding the B-frame has lowest bit rate, but consumes most computing power compared to I-frame and P-frame. The lower bit rate of B-frame compared to P-frame and I-frame is contributed by the factors including: the averaging block displacement of a B-frame to either previous or next frame is less than that of the P-frame and the quantization steps are larger than that in an I-frame or a P-frame. Due to bad quality caused by larger steps of quantization, B-frame is not to be reference in coding. Therefore, the encoding of the three MPEG pictures becomes tradeoff among performance, bit rate and image quality, the resulting ranking of the three factors of the three types of picture encoding are shown as below:

| | Performance | | |
|---|---|---|---|
| | (Encoding speed) | Bit rate | Image quality |
| I-frame | Fastest | Highest | Best |
| P-frame | Middle | Middle | Middle |
| B-frame | Slowest | Lowest | Worst |

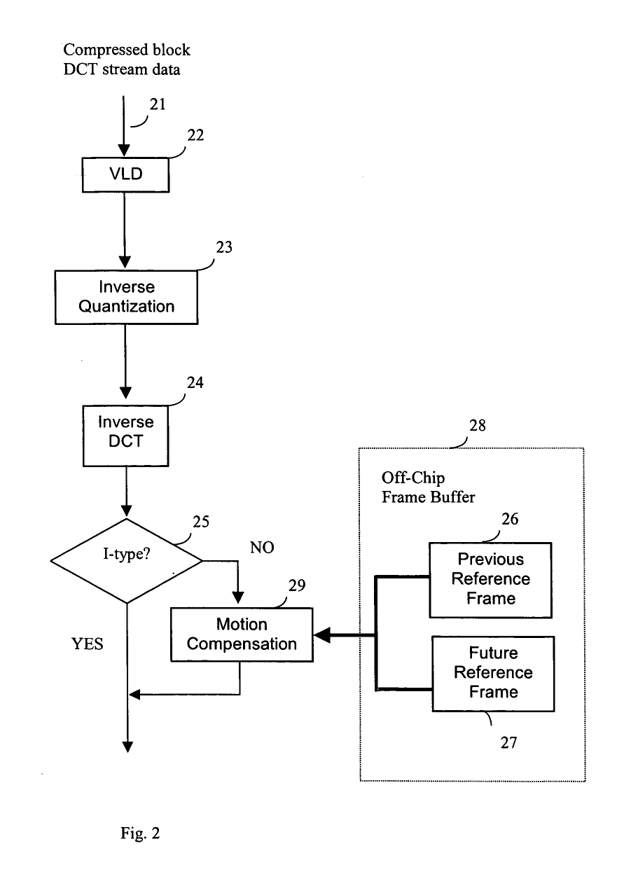

FIG. 2 illustrates the block diagram and data flow of the digital video compression procedure, which is commonly adopted by compression standards and system vendors. This video encoding module includes several key functional blocks: The predictor 22, DCT 23, the Discrete Cosine Transform, quantizer 25, VLC encoder 26, Variable Length encoding, motion estimator 24, reference frame buffer 29 and the re-constructor (decoding) 28 and a system layer encoder 27. The MPEG video compression specifies I-frame, P-frame and B-frame encoding. MPEG also allows macro-block as a compression unit to determine which type of the three encoding means for the target macro-block. In the case of I-frame or I-type macro block encoding, the MUX 220, a multiplexer selects the coming pixels 21 to go to the DCT 23 block, the Discrete Cosine Transform, which module converts the 8×8 pixels time domain data into 8×8 “coefficients” frequency domain. A quantization step 25 filters out some AC coefficients which do not dominate much of the information since they are located farer from the left top DC corner. The quantized DCT coefficients are packed as pairs of “Run-Level” code, which patterns will be counted and be assigned code with variable length by the VLC Encoder 26. The assignment of the variable length encoding depends on the probability of pattern occurrence. The compressed I-type or P-type bit stream is then reconstructed by the re-constructor 28, the reverse route of compression, and is temporarily stored in a reference frame buffer 29 for future frames' reference in the procedure of motion estimation and motion compensation. In the case of a P-frame, B-frame or a P-type, B-type macro block encoding, the coming pixels 21 of a macroblock are sent to the motion estimator 24 to compare with pixels of previous frames (and the next-frame in B-type frame encoding) to search for the best match macro-block. Once the best match macro-block is identified, the Predictor 22 calculates the block pixel differences between the target 8×8 block and the block within the best match macro-block of previous frame (or next frame in B-type encoding). The block pixel differences are then fed into the DCT 23, quantizer 25 and VLC encoder 26, the same procedure like the I-frame or I-type block encoding.

The Best Match Algorithm, BMA, is most commonly used motion estimation algorithm in the popular video compression standards like MPEG and H.26x. In most video compression systems, motion estimation consumes high computing power ranging from ˜50% of the total computing power of the video compression. In the search for the best match macro-block, a searching range, for example +/−16 pixels in both X- and Y-axis, is most commonly defined. The mean absolute difference, MAD or sum of absolute difference, SAD as shown below, is calculated for each position of a macro-block within the predetermined searching range, for example, a +/−16

$$SAD ( x , y ) = {\sum }_{i = 0}^{15} {\sum }_{j = 0}^{15} \vert {V}_{n} ( x + i , y + j ) - {V}_{m} ( x + dx + i , y + dy + j ) \vert$$

$$MAD ( x , y ) = \frac{1}{256} {\sum }_{i = 0}^{15} {\sum }_{j = 0}^{15} \vert {V}_{n} ( x + i , y + j ) - {V}_{m} ( x + dx + i , y + dy + j ) \vert$$

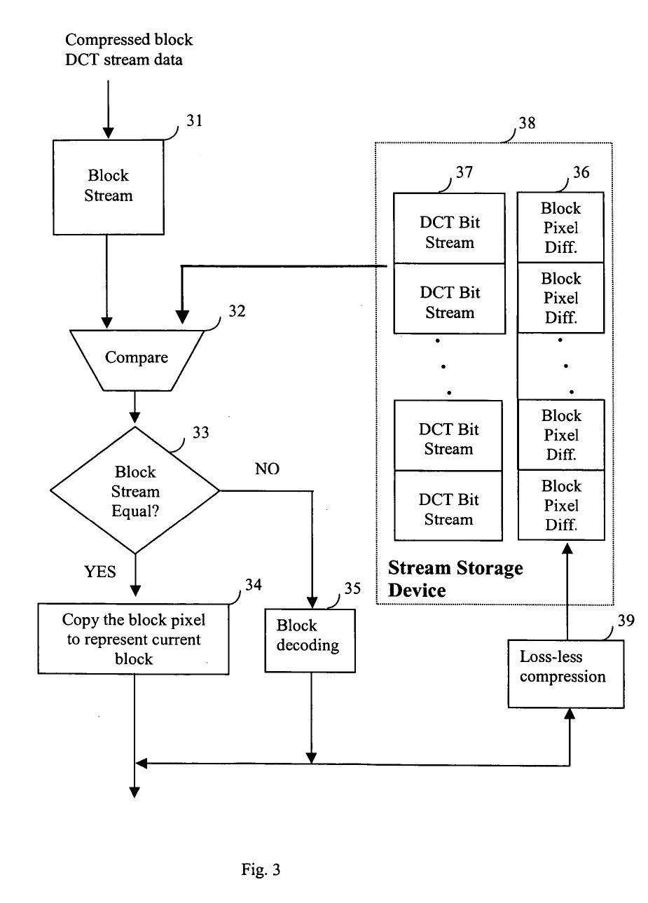

pixels of the X-axis and Y-axis. In above MAD and SAD equations, the Vn and Vm stand for the 16×16 pixel array, i and j stand for the 16 pixels of the X-axis and Y-axis separately, while the dx and dy are the change of position of the macro-block. The macro-block with the least MAD (or SAD) is from the BMA definition named the “best match” macro-block. FIG. 3 depicts the best match macro-block searching and the depiction of the searching range. A motion estimator searches for the best match macro-block within a predetermined searching range 33, 36, 39 by comparing the mean absolute difference, MAD or sum of absolute differences, SAD. The macro-block of a certain of position having the least MAD or SAD is identified as the “best match” macro-block. Once the best match blocks are identified, the MV between the target block 35 and the best match blocks 34, 37 can be calculated and the differences between each block within a macro-block can be coded accordingly, this kind of block pixel differences encoding technique is called “Motion Compensation”.

In most video compression IC implementations, for cost reason, the most common solution is to separate the referencing frames and store into an off-chip storage device 29 like a DRAM. In video applications, integrating referencing frames' buffer with the compression engine by a standard logic process costs high price due to larger silicon die. In the other approach of integrating the compression circuits into referencing frames' buffer by an embedded DRAM process also costs high price due to high cost of wafer of the embedded DRAM silicon with extra 6-8 layers of process and mask.

The present invention provides a method of reducing the amount of pixel data of the referencing frames which makes it feasible to integrate the referencing frames buffer together with the compression engine. In the present invention, the reconstructed frame pixels of an I-type or a P-type frame are compressed and saved in a temporary storage device for future use in motion estimation and motion compensation.

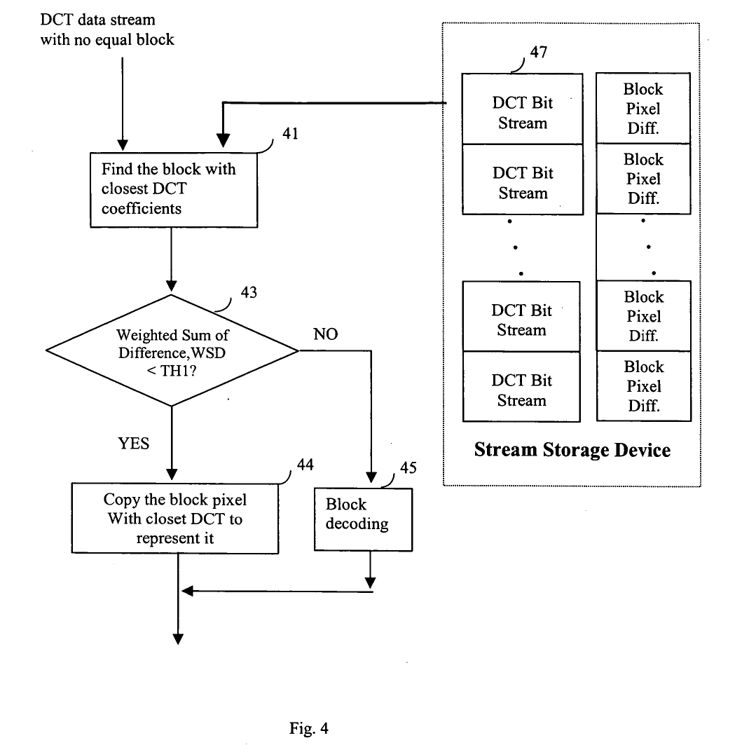

Reference is now made to FIG. 4 for explaining an embodiment according to the present invention. In FIG. 4, a group of blocks (GOB) 41, 42, 43 are applied. When a macroblock of a target frame needs to start the mechanism of motion estimation 46, the compressed frame pixels in GOB 41, 42 43 are decompressed and recovered 44 and stored in a pixel buffer 45 which is used to store pixels within the “searching range”, for example, a +/−16 pixel in the X-axis or a +/−16 pixels in the Y-axis.

Since the re-constructed frames are already compressed and some high frequency information have been filtered out by the step of quantization, a more uniform block pixels with closer pixel correlation within a block are expected. High correlation between blocks is also possible which results in the saving of compression time since there will be need of only for compressing those block pixels which has no identical one in the previously compressed blocks.

Similar to the scheme of compressing the referencing frame pixels, the present invention is applied to the compression of line pixels in a still image compression. For example, the JBIG, a standard used in an MFP, a multiple function printer combing scanner, printer and fax in one. In the most common solutions, for the consideration of performance, the pixel buffer of three lines of pixel is integrated into a JBIG codec engine since accessing a DRAM is a slow operation. The scanner and printing machine are already providing higher and higher pixel resolution ranging from 900 dpi (dot per inch) to 5600 dpi. Taking 3000 dpi, as an example, compressing an A4 size, 11×8 inches document by using JBIG requires at least 99K bits (11 inch×3000 dpi×3 lines=99K bits) of storage. In the VLSI chip implementation, an JBIG codec requires about 30K-40K logic gates, which means the 3 lines of image buffer will dominates more than 85% of die area since storage of each bit is equivalent to about 4 logic gates. According to the JBIG compression standard, a target pixel 64 is compared to the predicted value which is calculated by means of a prediction with surrounding pixels in left, in upper line 63 and in even upper line 62. The predicted valued is sent to the compression engine which adopts the “arithmetic” coding as the main compression algorithm.

For compliant to the JBIG standard, the present invention compress 72 the scanned bi-level pixel data 71 and store into a temporary buffer 73. When the prediction engine needs for a target pixel 76, the decompressor recovers the pixel and the decompressed pixels are sent back to a much smaller buffer 74, 75 according to the positions for the calculation of the prediction before it is sent to the image compressor 78. In a document picture with most white tone words or drawings, a lossless compression with compression rate ranging from 30 to 60 is very easily achieved. Which means that in average, the saving of the storage device is more than >97% is an easy work and which reduces the die size by a range of 80% to 90%.

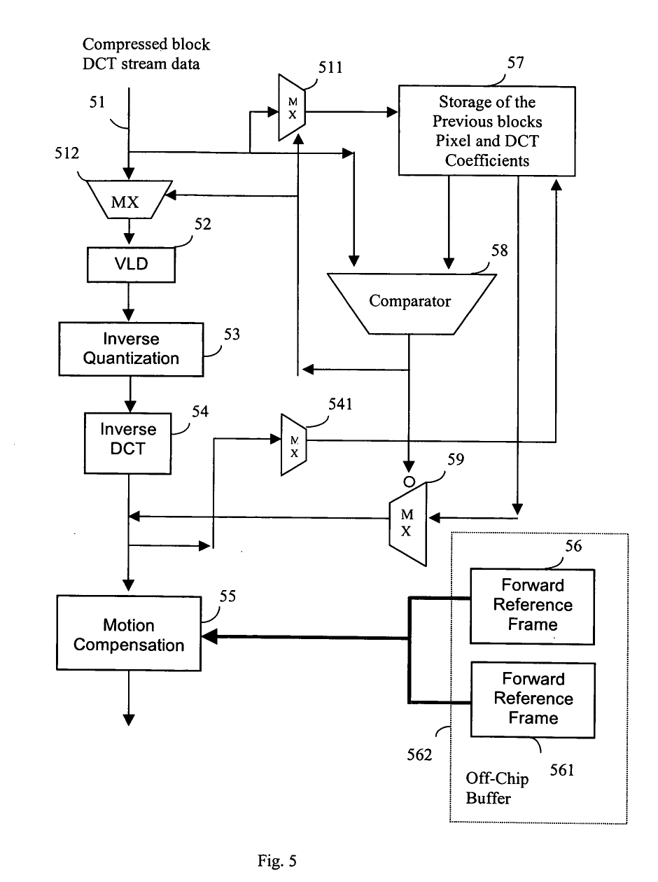

FIG. 5 illustrates the block diagram of the video compression incorporating the implementation of the present invention of referencing frames buffer pixel data compression. The compressed I-type or P-type frame is re-constructed 57 through a reversing process. The re-constructed frame pixel is fed into an image compression engine 571 which compresses pixel data by taking the advantage of high pixel correlation between adjacent pixels by using the DPCM, Differential Pulse Coded Modulation means and a kind of VCL coding means. The DPCM means calculates the differences between adjacent pixels or takes the difference between a predicted value and the target pixel. Using DPCM means reduces data amount. The compressed image data is stored into a temporary buffer 572. The block pixel decoder 573 recovers the block pixels when the motion estimator starts the best match block searching. Another temporary buffer 574 is implemented to save the pixels of a predetermined searching range for the motion estimation.

Since some high frequency data within a re-constructed block pixels are filtered out through quantization in encoding, the correlation between pixels of the re-constructed frame is very high and the lossless image compression should be able to easily achieve 4× compression rate. This makes it much feasible to integrate the referencing frames buffer with the video compression engine since the buffer size is around 4× smaller than without the present invention of the image buffer compression. Integrating the referencing buffer and compression engine into a single silicon chip can be done by using logic process or an so named embedded DRAM process.

It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

1. A method for encoding a video bit stream having a plurality of frames, each frame being composed of a plurality of blocks, the method comprising:
re-constructing frame pixels of a reference frame after compressing the reference frame;
compressing the re-constructed frame pixels of the reference frame into compressed re-constructed frame pixels;
storing the compressed re-constructed frame pixels in a temporary storage device; and
decompressing the re-constructed frame pixels within a searching range of a target block when calculating a motion vector of the target block, wherein the target block of a target frame is to be encoded by reference to the reference frame using the motion vector.

2. The method of claim 1, wherein the re-constructed frame pixels are compressed into forms of groups of blocks (GOB), and at least one group of GOB within the searching range is decompressed when calculating the motion vector.

3. The method of claim 1, further comprising a step for compressing at least one block of pixel of the referencing frame into GOB, group of blocks and decompressing at least one GOB into block pixels of a predetermined searching range for best match block searching in motion estimation.

4. The method of claim 1, wherein a DPCM, Differential Pulse Modulation and a VLC, Variable Length Coding techniques are applied to reduce the bit rate of at least one block within at least one re-constructed frame pixels.

5. A method for encoding a bit stream of a picture composed of lines of pixels, comprising:
losslessly compressing at least one line of pixels;
saving the at least one compressed line of pixels into a storage device; and
decompressing at least one pixel of at least one line of pixels for predicting the value of a target pixel to encode the target pixel.

6. The method of claim 5, wherein a prediction is done by calculating at least one pixels of the surrounding pixels of a target pixel.

7. The method of claim 5, wherein a DPCM and a VLC coding technique are applied to reduce the amount of pixel data.

8. An apparatus for encoding a video stream, comprising:
a re-construction device for re-constructing frames pixels of a reference frame after the reference frame is compressed;
a compression device for compressing the re-constructed frame pixels into compressed re-constructed frame pixels;
a temporary buffer for storing the compressed re-constructed frame pixels; and
a decompression device for decompressing pixels within a searching range of a target block when calculating a motion vector of the target block.

9. The apparatus of claim 8, wherein a single silicon chip is implemented to integrate the above devices.

10. The apparatus of claim 9, wherein a single silicon chip integrating the above devices is implemented by a CMOS logic process.

11. The apparatus of claim 9, wherein a single silicon chip integrating the above devices is implemented by a DRAM process.

12. The apparatus of claim 9, wherein a single silicon chip integrating the above devices is implemented by a Non-Valentine Memory process.
